(19) United States
(12) Patent Application Publication
(10) Pub. No.: US 2018/0218850 A1
(43) Pub. Date: Aug. 2, 2018

(54) MULTI-PANEL THICKNESS MOUNTING FOR SWITCH

(71) Applicant: Vita-Mix Management Corporation, Olmsted Township, OH (US)

(72) Inventors: William J. Bigge, Valley City, OH (US); Edmund T. Harbart, North Royalton, OH (US)

(21) Appl. No.: 15/742,903

(22) PCT Filed: Jul. 11, 2016
(86) PCT No.: PCT/US16/41684

§ 371 Date: Jan. 9, 2018

Related U.S. Application Data
(60) Provisional application No. 62/190,498, filed on Jul. 9, 2015.

(51) Int. Cl. H01H 9/02; H02B 1/048; H01H 23/08

(52) U.S. Cl. CPC H01H 9/0271; H01H 23/08; H02B 1/048

(57) ABSTRACT

A mounting switch is described herein. The mounting switch is mounted with a control panel. The mounting switch includes a front having a face and a bezel framing the face. The mounting switch includes a housing and an interface. A hard-stop tab is disposed on the housing. An edge of the hard-stop tab faces the bezel. A step tab is disposed on the housing. The step tab includes steps facing the bezel. The step tab and the hard-stop tab may secure the switch to the control panel.

### RELATED APPLICATIONS

This application claims the benefit of U.S. Provisional Patent Application Ser. No. 62/190,498, filed Jul. 9, 2015, and entitled “MULTI-PANEL THICKNESS MOUNTING FOR SWITCH,” the entirety of which is incorporated herein by reference.

### TECHNICAL FIELD

The present invention relates generally to switch assemblies, and has particular utility in facilitating installation of switches into a structure, for example, a kitchen appliance.

### BACKGROUND

Switches are typically mounted in a control panel of an appliance. In kitchen appliances, for example, switches are mounted to give users a way of controlling the appliance. These switches often include toggle switches, flip switches, and rocker switches that exist in a control panel. These switches can control functions of the appliance so that the operator may turn the appliance on/off and control settings of the appliance.

Control panels which switches are mounted to are not uniform in thickness. Panels of various thicknesses are common in the appliance industry; sometimes the panels are not even uniform within the same manufacturer. Some switches are designed to fit within a particular panel of a particular appliance, and often the same style of switch cannot be used on different appliances.

Traditionally, mounting of a switch to a control panel relies on the use of tabs to engage with the interior side of a control panel, providing retention for the switch. In some appliances, a switch has a mounting bracket with flexible tabs. The flexible tabs have multiple-level steps to allow for mounting at varying depths or with various control panels. The switch can be removed when force is applied to disengage the tabs from the control panel. If the switch is removed, electrical connections and electrical components may become exposed to potentially harmful environments.

In other switches, tabs are inflexible and have hard-stops to engage with the interior side of the panel, while a bezel of the switch engages an exterior surface of the panel. This secures the switch to the control panel. It, however, does not allow the switch to be used for different thicknesses of control panels. Further, using these switches with particular control panels may result in the switch being loose, damage to the control panel, or other results.

Accordingly, it is desirable to have an improved switch that may be utilized by various control panels, may be secured to control panels of different thicknesses, may reduce or prevent inadvertent removal of the switch, or otherwise improve the functionality of a switch.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

A switch mountable with a control panel is described herein. The switch comprises a face portion. The face portion comprises a bezel. The switch includes a housing operatively inserted within a control panel. The housing includes at least one step tap comprising one or more steps, the at least one or more steps facing the bezel and at least one hard-stop tab comprising an edge facing the bezel. When the switch is operatively mounted with the control panel, the control panel is operatively disposed between a step of the at least one step tap and the bezel, and the control panel is operatively disposed between the edge of the at least one hard-stop tab and the bezel. The housing is generally rectangular. A first step tap and a first hard-stop tab is disposed on a first side of the housing. A second step tap and a second hard-stop tab is disposed on a second side of the housing. The first step tap may be generally diagonally opposite the second step tap, and the first hard-stop tab is generally diagonally opposite the second hard-stop tab.

In an aspect, a peak distance of the step tab defines the distance from the first side to a furthest step of the step tab, and a peak distance of the hard-stop tab defines the distance from the first side to the furthest point of the edge. The peak distance of the step tab is generally less than the peak distance of the hard-stop tab. In another aspect, a distance between a furthest step of the step tab and the bezel is less than a distance between the edge of the hard-stop tab and the bezel.

This disclosure, in addition, describes a mounting switch mountable with a control panel. The mounting switch includes a housing comprising a face, a flange extending outwardly from the face, a first step tab disposed on a first side of the housing, wherein the first step tab comprises a plurality of steps, and a first hard-stop tab disposed on the first side of the housing, wherein the first hard-stop tab comprises an edge generally perpendicular with the flange.

A mounting switch is described that includes a face, a bezel generally circumscribing the face, a housing extending from the bezel, a hard-stop tab comprising a hard-stop edge and protruding from the housing, and a step tab comprising a plurality of steps and protruding from the housing spaced from stop tab, wherein the further step of the plurality of steps is a first distance from the bezel and the hard-stop edge is a second distance from the bezel.

The following description and the drawings disclose various illustrative aspects. Some improvements and novel aspects may be expressly identified, while others may be apparent from the description and drawings.

### DESCRIPTION OF THE DRAWINGS

Objects and advantages together with the operation of the invention may be better understood by reference to the following detailed description taken in connection with the following illustrations, wherein:

FIG. 1 is a perspective view of the back of a multi-panel thickness mounting switch;

FIG. 2 is a side view comparing a hard-stop tab and a step tab;

FIG. 3 is another side view comparing a hard-stop tab and a step tab;

FIG. 4 is another perspective view of the back of a multi-panel thickness mounting switch;

FIG. 5 is a perspective view of the front of a multi-panel thickness mounting switch;

FIG. 6 is a perspective view of a side of a multi-panel thickness mounting switch;

FIG. 7 is a side view of a multi-panel thickness mounting switch;

FIG. 8 is a top view of a multi-panel thickness mounting switch;

FIG. 9 is a front view of a multi-panel thickness mounting switch; and

FIG. 10 is a side view of a multi-panel thickness mounting switch and a cross-sectional view of a control panel.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

Switches may be used in an appliance or other device to control operations of the appliance. For example, blenders may utilize switches to allow a user to control operations of a motor of the blender. The user may manipulate the switch (e.g., “flip,” “press,” etc.) to turn the motor on/off, pulse the motor, select a blending operation, or the like. In some appliances, the switch may be mounted within a blender base and/or a control panel. In an example, the blender base includes a port that operatively receives the switch. The switch is mounted within the port. The switch may have a tab and a bezel. The tab has a ledge that faces the bezel. The switch is pushed or otherwise forced into the panel. The panel and/or the tab flex and snap into place as the switch is appropriately disposed in the panel. The panel may be disposed at a space between the ledge and bezel to secure the switch to the panel.

In some traditional switches, the tab has “steps” on the tabs that engage the interior side of the panel. These steps provide retention for the switch. Tabs with the stair case design may become lose or may be dislodged when force is applied to the tab. Thick panels may retain switches solely due to the spring force of the tabs. When force is applied, the switch may come completely out of the panel, allowing access to the electronics to which the switch was previously connected.

Another switch design uses a hard-stop-type. The hard-stop-type switch have tabs with one ledge or stair. The tab, in addition, may be rigid or less flexible than those of the step-type switch. When the hard-stop-type switch is inserted in the control panel, it is often less susceptible to a force causing the switch to become loose or dislodged in comparison with the step-type switch. These hard-stop-type switches are typically designed for one thickness of a control panel.

In some appliances or other devices, the thickness of a control panel may vary. This may be true for the same model of device. For example, a device may be originally designed with a control panel having a specific thickness. The thickness of the control panel, however, may be changed over time. This may be due to labels added to the control panel. Embodiments described herein may allow for an improved or more efficient switch that may address this and other issues. For instance, disclosed switches may be utilized with control panels of various thicknesses. This may allow for greater flexibility in the design and modification of devices, increased manufacturing ability, and the like.

According to disclosed embodiments, a switch may be mountable with a control panel. The switch may comprise a face portion comprising a bezel and an insert body operatively inserted within a control panel. The face portion may operatively include an interface for human interaction (e.g., button, touch sensor, toggle switch, etc.). The insert body may comprise at least one step tap comprising one or more steps disposed on a spring body, the at least one or more steps facing the bezel. In another aspect, the insert body may comprise at least one hard-stop tab comprising a rigid body and a ledge. The switch may be operatively mounted with the control panel, the control panel is operatively disposed between a step of the at least one step tap and the bezel, and the control panel is operatively disposed between a ledge of the at hard-stop tab and the bezel. According to embodiments, the step tab may allow for mounting within a range of thicknesses. The hard-stop tab may prevent or reduce the ability to dislodge the tab from the panel.

Embodiments may refer to a “switch,” “mounting switch,” or the like. It is noted that such terms are utilized for sake of brevity and explanation. Accordingly, such terms may generally refer to other controls or components that may be mounted (e.g., knobs, buttons, touch sensors, or the like). These terms may be utilized interchangeably unless context suggests otherwise or warrants a particular distinction among such terms. It is further noted that while switches are described as mounted with or on a “control panel” or “panel,” the disclosed switches may be mounted with or on various other devices or components. A switch, for example, may be mounted on a side of an appliance. As such, the terms “control panel” and/or “panel” may generally refer to any component configured to receive a switch. Moreover, such terms may be utilized interchangeably unless context suggests otherwise or warrants a particular distinction among such terms.

Referring now to the figures, there is a switch 100. The components of the switch 100 may be made of any appropriate material, including, but not limited to, a suitable rubber, plastic (such as polyethylene terephthalate, high density polyethylene, polyvinyl chloride, low density polyethylene, polypropylene polycarbonate, copolyester, or a combination of such) or metal material (such as aluminum or stainless steel). Moreover, while described as separate components, the components may be monolithically formed, attachable (e.g., removably or irremovably), or otherwise assembled. In another aspect, various modifications are within the scope and spirit of this disclosure.

The switch 100 may comprise a housing 102 to be any appropriate shape, including a polygon, triangular-prism, curved, irregular in shape, or the like. In an example, housing 102 may comprise a generally rectangular shape. A first side or bottom 112 may be opposed to a second side or top 118. A third side 116 and a fourth side 117 may connect the bottom 112 with top 118. In an aspect, third side 116 and fourth side 117 may each comprise a solid surface or may include at least one aperture. The housing 102 may comprise a fifth side or face 120 and a sixth side or back 122. While orientations such as top, back, front, side and bottom are used to describe relative orientations, any appropriate nomenclature may be utilized. As such, these terms describe orientations relative to the drawings for simplicity of explanation.

According to embodiments, back 122 may include at least one interface 124. For instance, an interface 124 may include a number of terminals 125. Embodiments of the present disclosure may include other types of interface, such as Universal Serial Bus (USB), micro-USB, pinned connections, or the like. The interface 124 may operatively connect or couple with a port (not shown) of a device. The port of the device may receive interface 124. For instance, terminals 125 of interface 124 may be made of a conductive material, such as metal, copper or steel. The back 122 may also include at least one divider 126. The divider 126 can be made of any appropriate material, including, but not limited to, a plastic or a metal. The divider 126 can span part of or the entire length or width of the back 122. The divider 126 may also protrude from the bottom 112 of the switch 100. In an aspect, the divider 126 may provide a physical barrier between positive and negative terminals 125. It is noted that divider 126 may comprise other configurations, shapes, and sizes in accordance with the scope and spirit of this disclosure.

As described herein, housing 102 may comprise at least one step tab 138 and at least one hard-stop tab 128. It is noted that embodiments may include different numbers of step tabs and/or hard-stop tabs. For example, embodiments may include i step tabs 138 and j hard-stop tabs 128, where i and j are numbers, which may be the same or different. In at least one embodiment, housing 102 may include two step tabs 138 and 139. The housing 102 may include two hard-stop tabs 128 and 129.

The hard-stop tabs 128/129 may be disposed on opposed sides of the housing 102 relative to each other. For instance, hard-stop tab 128 may be disposed on top 118 and hard-stop 129 may be disposed on bottom 112. In another aspect, hard-stop tab 128 may be disposed on side 116 and hard-stop 129 may be disposed on side 118. Moreover, hard-stop tabs 128/129 may be disposed at various locations along the housing 102, such as near a corner, middle, or other location of a side.

Each hard-stop tab 128/129 may comprise ledge or face 132 and 133, respectively. The faces 132/133 may be disposed generally perpendicular to a bezel 136—which may comprise back surface 136—of the housing 102. The bezel 136 may generally frame a front the face 120 of the housing 102. In an aspect, the bezel 136 may extend perpendicularly relative bottom 112, top 118, side 116, and/or side 117. Each face 132/133 and the bezel 136 may form a channel 125.

The step tabs 138/139 may be disposed on opposed sides of the housing 102 relative to each other. For instance, step tabs 138 may be disposed on top 118 and step tabs 139 may be disposed on bottom 112. In another aspect, step tabs 138 may be disposed on side 116 and step tabs 139 may be disposed on side 118. Moreover, step tabs 138/139 may be disposed at various locations along the housing 102, such as near a corner, middle, or other location of a side. It is noted that the various tabs may be disposed at other locations in accordance with this disclosure.

Each step tab 138/139 may comprise ledge or face 132 and 133, respectively. The faces 132/133 may be disposed generally perpendicular to a bezel 136 of the housing 102. The bezel 136 may generally frame a front of the face 120 of the housing 102. In an aspect, the bezel 136 may extend generally perpendicularly relative bottom 112, top 118, side 116, and/or side 117. It is noted that the bezel 136 may or may not completely frame the face 120. For instance, bezel 136 may comprise one or more sections of material that extend from one or more side of the housing 102. Such modifications and various alternatives are within the scope and spirit of this description.

Turning now to FIG. 10, with reference to the other figures, the switch 100 may be coupled with a control panel 200. In an aspect, the control panel 200 may comprise a panel of an appliance (e.g., a blender, etc.). Embodiments may refer to a user or machine pressing the switch 100 into the control panel 200, however, various other methods of connecting the switch 100 to the control panel 200 may be utilized and are within the scope and spirit of this disclosure. As such, it is noted that pressing the switch 100 in the control panel 200 will be discussed in the various examples for simplicity of explanation.

Control panel 200 may comprise an aperture 210 sized and shaped to receive the switch 100. In an aspect, control panel 200 may comprise a shell or portion of a shell or housing of an appliance. For instance, a blender device (not shown) may comprise the control panel 200. The control panel 200 may comprise an appropriate material, such as plastic, glass, metal, or the like. The control panel 200 may operatively receive the switch 100 to enable a user to operate the blender. The interface 124 may be received by a port (not shown).

The switch 100 may be pressed into the aperture of the control panel 200 (e.g., such as back side 122 first). As the switch 100 is pressed into the control panel 200, the various tabs of the switch and/or the control panel 200 may be deformed, compressed, flexed, or otherwise manipulated to allow the switch 100 to be appropriately positioned. For instance, the at least one step tabs 138/139 and the at least one hard-stop tabs 128/129 may flex as the control panel 200 pushes against or compresses the tabs. The control panel 200 and/or tabs 128/129/138/139 may snap into place when the control panel 200 reaches an appropriate position. The position may depend on the width of the control panel 200.

In an example, control panel 200 may comprise a width 202. The width 202 may be generally equal to or less than a width 204 that is defined by a distance between a step 206 and bezel 136 (e.g., back surface 137 of bezel 136). As the switch 100 is inserted in the control panel 200, the control panel 200 may be disposed between other steps of the step tabs 138/139. Once the control panel 200 is disposed between step 206 and bezel 136, it may not be inserted further as the distance between the remaining steps and the bezel 136 is less than width 204 and/or width 202.

The space between the steps of each step tab 138/139 and the bezel 136 may be represented by channel 135. In another aspect, the space between each hard-stop tab 128/129 and the bezel 136 may be represented by channel 125. The channels 125/135 may be of any appropriate configuration. In some embodiments, the channels 125/135 may be configured to accept the control panel 200 as described in more detail herein. The first hard-stop tab 128 may be in continuous contact with side 118 of the switch 100, or there may be an aperture 300 between the first hard-stop tab 128 and the side 118 of the switch 100. The aperture 300 may allow the first hard-stop tab 128 to flex as pressure is applied. The first hard-stop tab 128 can be made of any appropriate material, including, but not limited to, a plastic. The first hard-stop tab 128 can be inflexible or it can be flexible.

This design may allow all four tabs 128, 129 138, and 139 to compress upon insertion into aperture 210. The compressed tabs 128, 129 138, and 139 can pass through the opening, and the geometry of the tabs 128, 129 138, and 139 may create a restorative force that allows the tabs 128, 129 138, and 139 to return to their original position after passing through the opening.

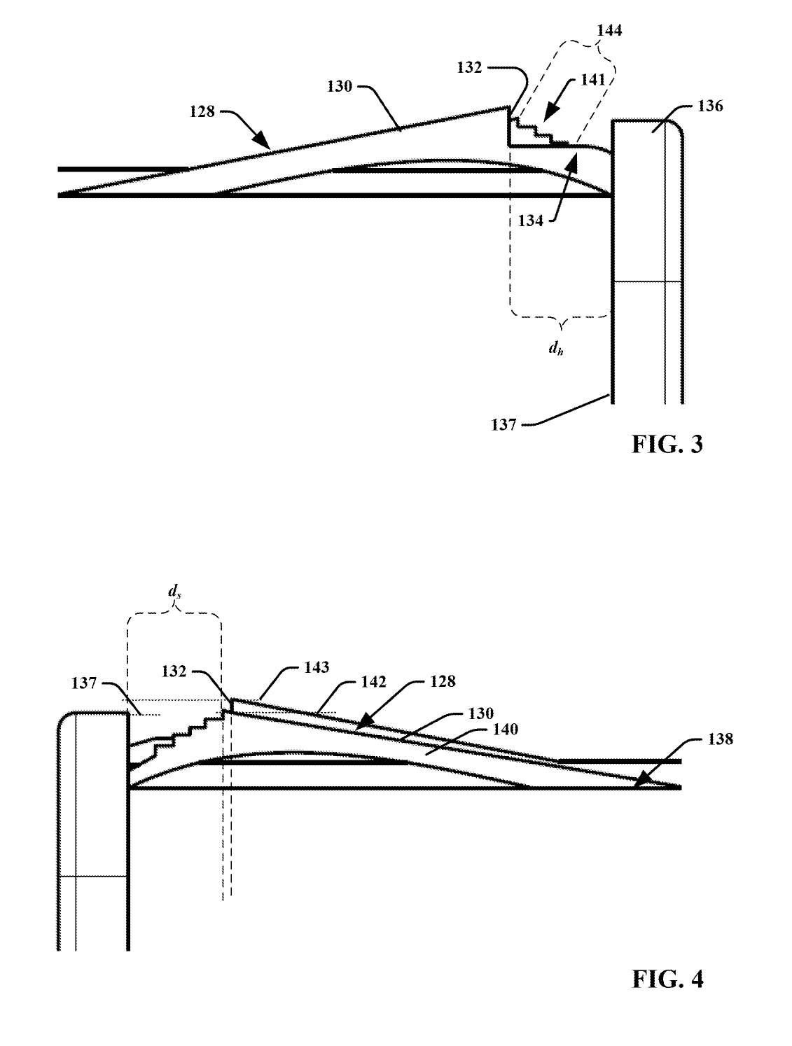

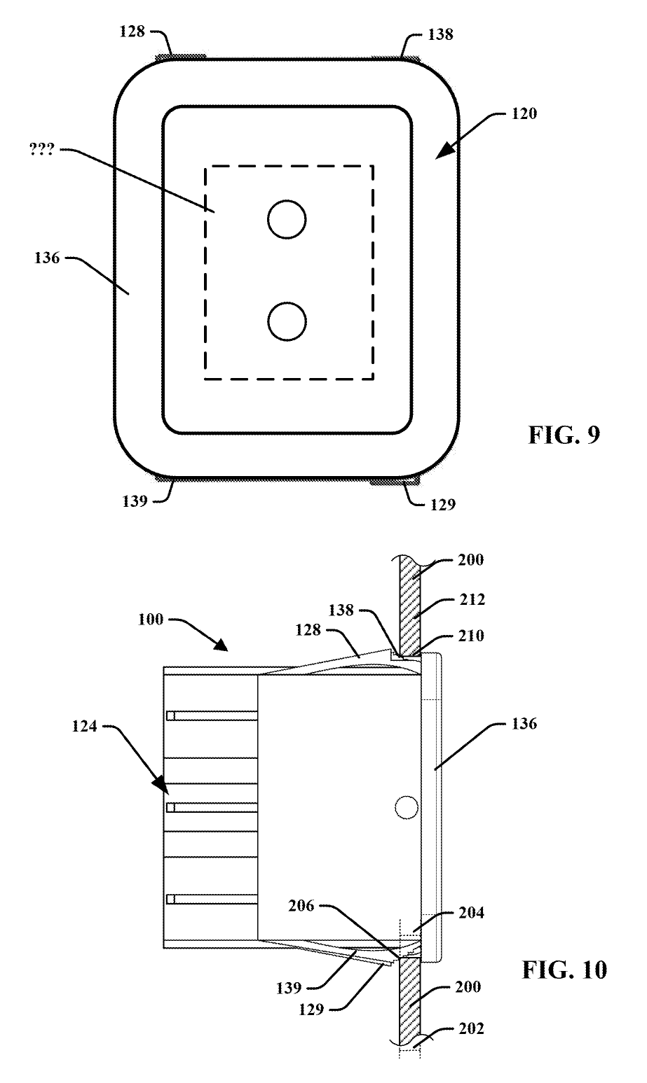

Turning now to FIGS. 3-4, with reference to the other figures, there is a smaller distance dₛ between the step tab 138 and the bezel 136 than the distance dₕ between the hard-stop tab 128 and the bezel 136, the step tabs 138, 139 make contact with the panel opening and fix the switch 100 in place within the panel opening. In this embodiment, the channels 125/135 may be configured to generally hold and keep the switch 100 within the control panel 200. Upon insertion of the switch 100 into the aperture 210, the bezel 136 may lay generally flush against an exterior surface 212 of the panel 200. The step tabs 138, 139 lock into the closest possible distance between the step tabs 128, 129 and the backside of the bezel 136. The diagonal arrangement of the step tabs 138, 139 provides a consistent locking force around the bezel 136. The diagonal arrangement, as shown in FIG. 9, refers to step tabs 138 and 139 being disposed generally diagonally opposite or catty-corner with respect to housing 102. It is noted that the step tabs 138/139 and the hard-stop tabs 128/129 may alternate positions about the housing 102 of the switch 100. The diagonal arrangement of the step tabs 138, 139 provides a consistent locking force around the bezel 136.

It is noted that embodiments may include other arrangements of hard-stop tabs and step tabs. For instance, an embodiment may include a side having two step tabs and a hard tab, two hard tabs and a single step tab, or the like. In other embodiments, each side may include a single tab, where tabs of the same type are generally opposite each other.

The step tabs 138, 139 alone may secure the switch 100 of a panel of a distance less than the further possible distance dₛ between step tab 138 and the bezel 136. If the thickness of the panel is greater than this distance dₛ, the step tabs 138, 139 may not provide enough retention force to secure the switch 100 in the panel. Then, the applied force may overcome the retention force, thus allowing the switch 100 to come out of the panel. However, since the edges 132/133 of the hard-stop tabs 128/129 are taller than the aperture 210, the edges 132/133 may act as a catch, and prevent the switch 100 from coming out of the control panel 200.

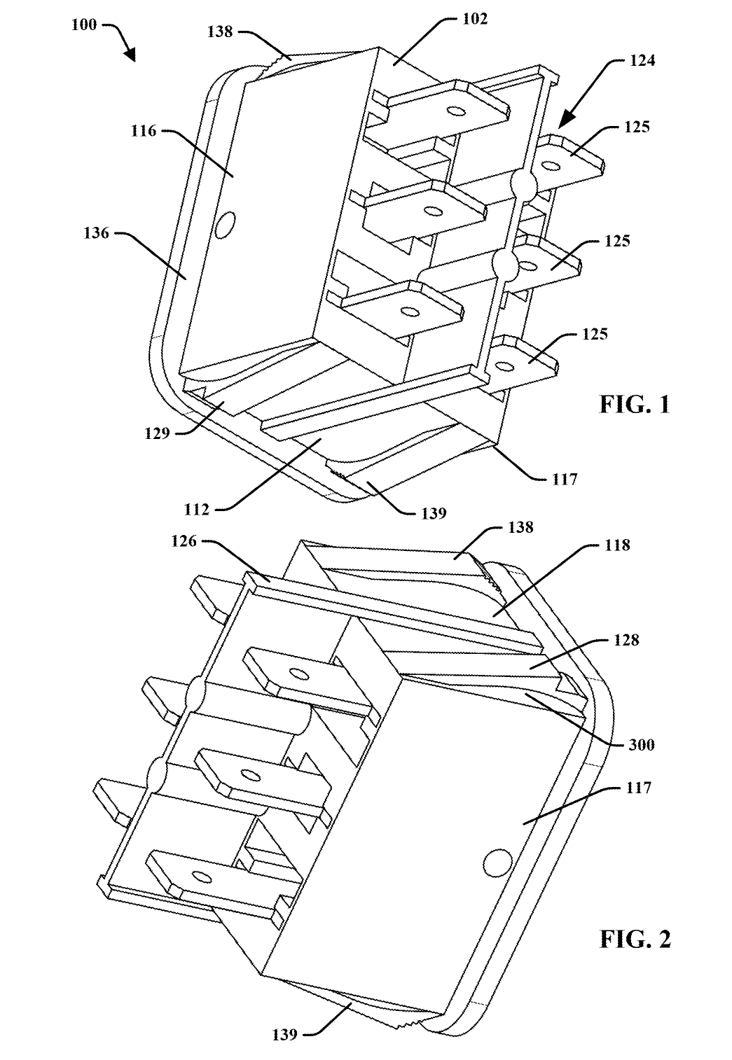

The present teachings may have different numbers and arrangements of the tabs 128, 129, 138, 139 and provide the same secure position of the switch 100 in the panel. For example, if the switch 100 is rectangular, the tabs 128, 129, 138, 139 may be placed in an alternating pattern on the long sides of the rectangle rather than on the short sides of the rectangle as shown in FIGS. 1-10. Additionally, the switch 100 can have more than four tabs. Alternatively, the switch 100 can have less than four tabs so long as the switch properly mounts to the panel while accepting various thicknesses of panels. Further still, the switch 100 can be of any appropriate shape, e.g., generally circular, oval, square, triangular, hexagonal, pentagonal, etc.

In another aspect, the hard-stop tab 128 can span the length of the side 118 from the back 122 to the face 120 on one side of the side 118. For example, the first hard-stop tab 128 can have a first body or length 130 extending from proximal back 122 at an acute angle towards the face 120. The first length 130 may extend to edge 132 that extends at a generally perpendicular angle—or other angle—towards the side 118 of the switch 100. A second length 134 of the first hard-stop tab 128 may extend from the edge 132 to a bezel 136. It is noted that the first length 130 and second length 134 may comprise other configurations. For instance, first length 130 may terminate at other locations not proximal to the back 122. In another aspect, second length 134 may terminate, curve, or otherwise be configured according to an appropriate geometry. The hard-stop tab 128 may comprise a peak 143 height that defines a highest point of edge 132 relative to side 118. It is noted that portions of body 130 may extend higher than peak 143. For instance, body 130 may comprise a spring tab that extends beyond peak 143.

At an opposite side of the side 118 from the first hard-stop tab 128, there is a first step tab 138. The first step tab 138 can be parallel or generally parallel to the first hard-stop tab 128. The first step tab 138 can span the length of the side 118 from the back 122 to the face 120 on the opposite side of the side 118 or may be shorter than such. The first step tab 138 has a first body or length 140 extending from the back 122 of the switch 100 at an acute angle towards the face 120. The first length 140 may extend to a peak 142 and a step length 144 that extends at a descending angle towards the face 120 of the switch 100, contacting the side 118 at a point of meeting for the bezel 136 and the side 118 of the switch 100. The step length 144 can have multiple ridges or steps 141. The ridges or steps 141 may be configured to engage the panel as described in more detail below. The first step tab 138 may be in continuous contact with the side 118 of the switch 100 or there may be an aperture between the side 118 and the first hard-stop tab 128 of the switch 100. The first step tab 138 can be made of any appropriate material, including, but not limited to, a plastic. The first step tab 138 can be inflexible or it can be flexible. As shown in FIGS. 2 and 3, the distance between the side 118 and the peak 142 of the first step tab 138 may be generally less than the distance between the side 118 and the peak 143 of the first hard-stop tab 128. It is noted, however, that the peak 143 and peak 142 may be differently configured. For instance, the height of peak 142 may be equal to or greater than the height of peak 143.

In another aspect, the peak 143 of the first hard-stop tab 128 may be taller than the height 137 of the bezel 136 as measured from side 118. The height 137 may be equal to, less than, or greater than the height of the peak 142. Additionally, the distance dₛ between the peak 142 of the first step tab 138 and the bezel 136 may be less than the distance dₕ between the edge 132 of the first hard-stop 128 and the bezel 136.

It is noted that the second hard-stop tab 129 and the second step tab 139 may comprise similar geometries and configurations as first hard-stop tab 128 and the first step tab 138, respectively. In various other embodiments, the second hard-stop tab 129 and the second step tab 139 may comprise other or different configurations than first hard-stop tab 128 and first step tab 138.

As shown in FIG. 4, the top 118 of the switch 100 can have at least one divider 126. The divider 126 can span the length of the top 118, or the divider 126 can be shorter than the length of the top 118. The divider 126 can also protrude from the top 118 of the switch 100. In addition to the divider 126, the top 118 also has a second hard-stop tab 129, which can span the length of the top 118 from the back 122 to the face 120 on one side of the top 118.

At an opposite side of the top 118 from the second hard-stop tab 129, there is a second step tab 139. Therefore, the second step tab 139 on the top 118 of the switch 100 can be on the same side of the switch 100 as the first hard-stop tab 128 on the side 118 of the switch 100.

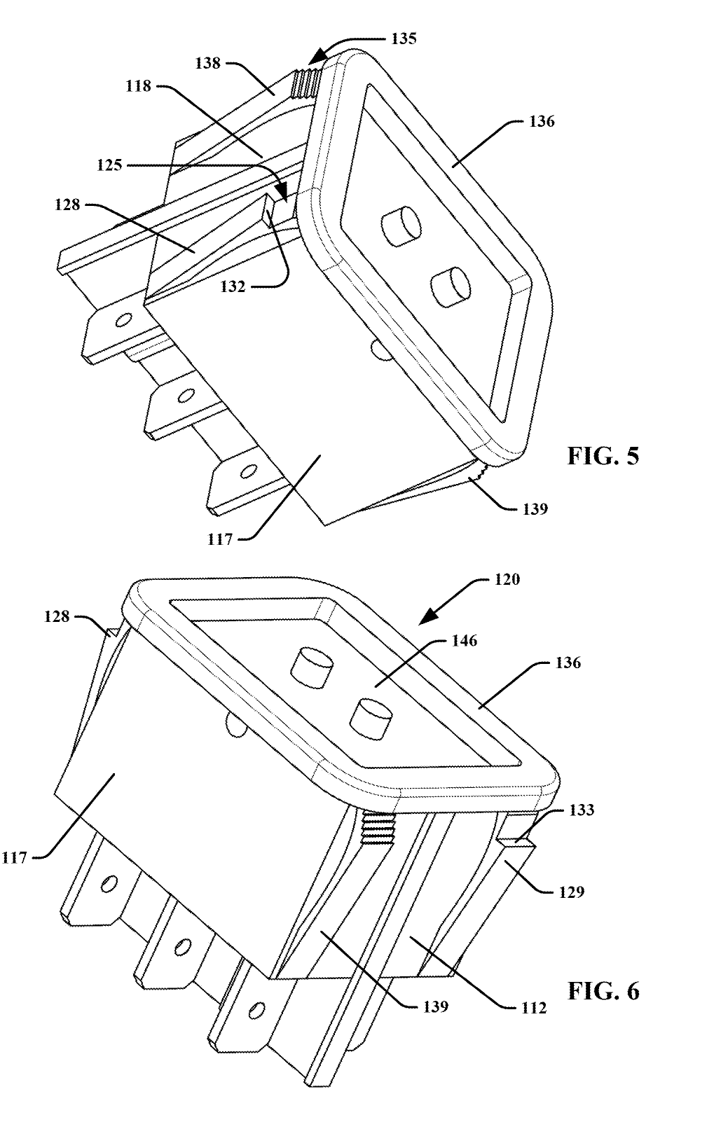

As shown in FIGS. 5 and 6, the face 120 of the switch 100 may comprise a user interface 146 bordered by the bezel 136. The interface 146 can be set back from the bezel 136, enabling the face 120 to receive a toggle of a switch. The interface 146 can be flat, or it can have a raised surface, or it can have at least one aperture, enabling the front to better receive a toggle of a switch. The interface 146 can be of any configuration, the present teachings are not limited to the configurations shown. These configurations are merely exemplary.

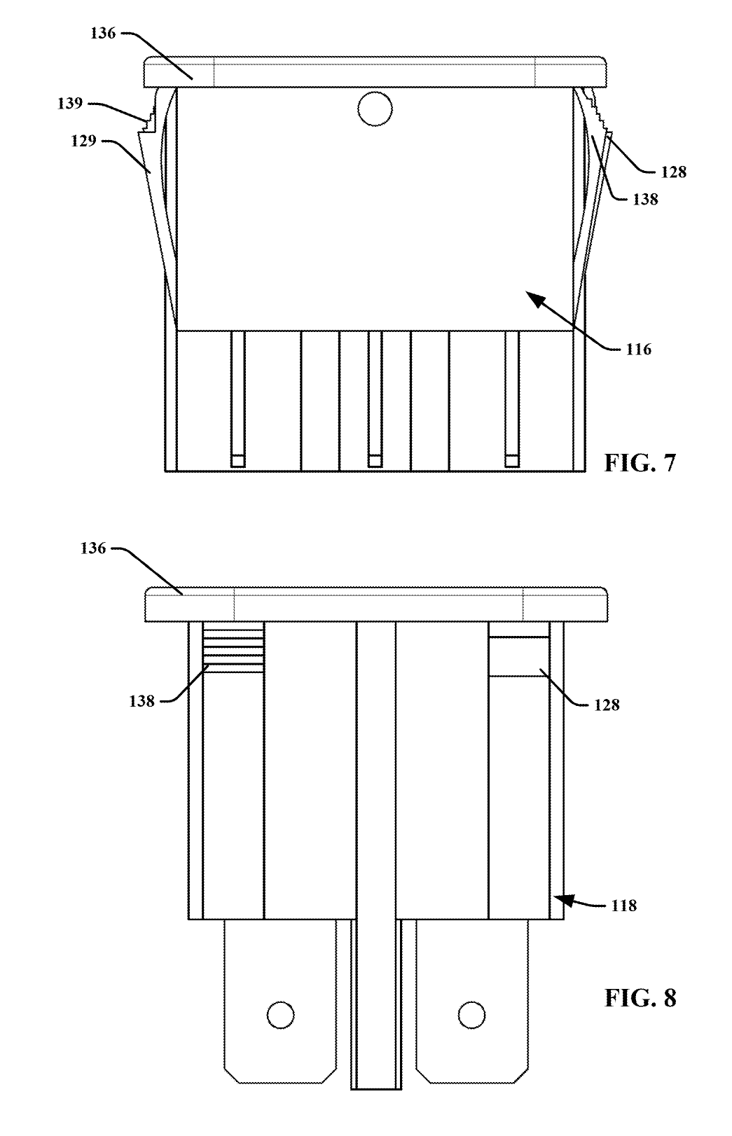

FIG. 7 illustrates a side view of the switch 100 showing the second step tab 139 and the second hard-stop tab 129 positioned on the ends of the top 118 and the side 118 of the same side 116.

FIG. 8 shows the first hard-stop tab 128 and the first step tab 138 spaced apart on side 118.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A switch mountable with a control panel, the switch comprising:
a face portion comprising a bezel;
a housing operatively inserted within a control panel, the housing comprising:
at least one step tap comprising one or more steps, the at least one or more steps facing the bezel; and
at least one hard-stop tab comprising an edge facing the bezel,
wherein, when the switch is operatively mounted with the control panel, the control panel is operatively disposed between a step of the at least one step tap and the bezel, and the control panel is operatively disposed between the edge of the at least one hard-stop tab and the bezel.

2. The switch of claim 1, wherein the housing comprising a first side and a second side opposed to the first side.

3. The switch of claim 2, wherein the first side comprises a first step tap of the at least one step tab, and a first hard-stop tab of the at least one hard-stop tab.

4. The switch of claim 3, wherein the second side comprises a second step tap of the at least one step tab, and a second hard-stop tab of the at least one hard-stop tab.

5. The switch of claim 4, wherein the first step tap is generally diagonally opposite the second step tap, and the first hard-stop tab is generally diagonally opposite the second hard-stop tab.

6. The switch of claim 3, wherein a peak distance of the step tab defines the distance from the first side to a furthest step of the step tab, and a peak distance of the hard-stop tab defines the distance from the first side to the furthest point of the edge, and
wherein the peak distance of the step tab is less than the peak distance of the hard-stop tab.

7. The switch of claim 3, wherein a distance between a furthest step of the step tab and the bezel is less than a distance between the edge of the hard-stop tab and the bezel.

8. The switch of claim 1, wherein the housing comprises a generally rectangular shape.

9. The switch of claim 1, further comprising at least one interface operatively coupled to a port of a device.

10. A mounting switch mountable with a control panel, the mounting switch comprising:
a housing comprising a face;
a flange extending outwardly from the face;
a first step tab disposed on a first side of the housing, wherein the first step tab comprises a plurality of steps; and
a first hard-stop tab disposed on the first side of the housing, wherein the first hard-stop tab comprises an edge generally perpendicular with the flange.

11. The mounting switch of claim 10, wherein the housing comprises a second side generally opposite the face, and wherein the first step tab comprises a body extending at an upwards angle towards the face from proximal the second side.

12. The mounting switch of claim 11, wherein the first hard-stop tab comprises a body extending at an upwards angle towards the face from proximal the second side.

13. The mounting switch of claim 10, wherein the plurality of steps forms a first channel with the flange, and the edge forms a second channel with the flange.

14. The mounting switch of claim 13, wherein the first channel and second channel operatively receive a control panel.

15. The mounting switch of claim 10, further comprising a second step tab and a second hard-stop tab, and wherein the tabs alternate about a perimeter of the housing such that the first hard-stop tab and the second hard-stop tab are not adjacent with each other.

16. The mounting switch of claim 10, wherein the flange extends a first distance from the housing, and the edge extends a second distance from the housing, wherein the second distance is greater than the first distance.

17. A mounting switch comprising:
a face;
a bezel generally circumscribing the face;
a housing extending from the bezel;
a hard-stop tab comprising a hard-stop edge and protruding from the housing; and
a step tab comprising a plurality of steps and protruding from the housing spaced from stop tab, wherein the further step of the plurality of steps is a first distance from the bezel and the hard-stop edge is a second distance from the bezel.

18. The mounting switch of claim 17, wherein the first distance is greater than the second distance.

19. The mounting switch of claim 17, wherein the hard-stop tab and the step tab on the base are generally parallel.

20. The mounting switch of claim 17, wherein the hard-stop tab and the step tab are flexible.
